(19) United States
(12) Patent Application Publication
(10) Pub. No.: US 2013/0294457 A1
(43) Pub. Date: Nov. 7, 2013

(54) METHOD OF AUTOMATED DIGITAL MULTI-PROGRAM MULTI-SIGNAL COMMUTATION

(71) Applicants: Borys Evgenijovych Panchenko, Kiev (UA); Dmitrij Andreevich Pechenjuk, Sumy (UA)

(72) Inventors: Borys Evgenijovych Panchenko, Kiev (UA); Dmitrij Andreevich Pechenjuk, Sumy (UA)

(21) Appl. No.: 13/822,608

(22) PCT Filed: Nov. 29, 2010
(86) PCT No.: PCT/UA10/00087

§ 371 Date: Mar. 12, 2013

(30) Foreign Application Priority Data
Sep. 15, 2010 (AU) 201011086
Oct. 22, 2010 (AU) 201012522

(51) Int. Cl. H04J 3/06

(52) U.S. Cl. CPC H04J 3/062
USPC 370/412

(57) ABSTRACT

A method of automated digital multi-program multi-signal commutation of analogue or digital incoming signal with packet, i.e. periodically discreet structure, is considered. Such type of signals is used in the communication area, in television and radio, surveillance systems and computer networks. The method provides synchronized group switching of analogue or digital signals from a considerable number of sources (fifty, one hundred, one thousand, etc.). A situation, when there is no opportunity of preliminary synchronization of signal sources, is considered. It is conditioned by the need of simultaneous work of several users and commutation of an increased number of incoming signals, and therefore the need of usage of various signal sources from different producers, and also the ones that are considerably remote from the commutation points. The multi-user technology is provided by means of controlled multiplication of incoming signals which, in their turn, provide several users with the ability of simultaneous real-time work. In the case of video signals it allows, in particular, to effectively solve the technical problem of aggregation of a considerable number of incoming video signals into a resultant composite panorama. An effective solution of a classical problem of broadcast unification of multitudes of attributes is also offered: television channel signals, foreign segments of television programs, times of remote starts of each of the segments, broadcasting areas, customers of commutation insertions, owners of television channel rights, etc. Herewith if in the process of exploitation the user detects a new multitude of attributes, not considered before exploitation, the method implies natural integration of these new multitudes.

The invention is related to the field of telecommunication technology and can be used upon designing and building devices with a real-time synchronized commutation of analogue or digital signals with a packet, i.e. periodically-discreet structure. Such type of signals is used in the field of communication, in television and video networks, surveillance systems and real-time computer networks, etc.

All terms and definitions that are not well-known are brought together in a separate dictionary and are placed in the final part of the description.

Input signals are considered, in each of which the moments of the beginning of packet movement occurred by the accidental principle. That is, the beginning of the existence of these signals is not synchronized. Such typical situation occurs if, for example, the users turn them on at different moments of time. The packet movement in each of the signals has constant or variable characteristics. The invention considers a situation when at the time of switching from one input signal to another one, integrity of the packets of signal is critical, as every time in the case of non-synchronized switching the first packets of a signal, included in the output, are destroyed—the so-called packet disruption occurs. Typical examples are a signal coming out of a camera, a computer's VGA signal or a signal of a television broadcast, in which a video frame is a packet. Destruction of video frames at the time of switching of such signals is inadmissible.

There exists a well-known method of synchronization which lies in the fact that thanks to simultaneous digital buffering of packets of all input signals, moments of the start of packet movement of input analogue or digital signals are synchronized, and after that, during the pause, i.e. transition to the next packet, synchronized switching is provided. On the mentioned principle famous television signal commutation devices are built—widely known commuting video mixer console from companies like “Sony” (like, for example, the DFS-700 model), “Panasonic” (model MX-70), “Teleview” (model DSC 655) or video mixer console from the “Datavideo” firm. Nevertheless they all have one significant drawback—limited number of signals that are subject to commutation. This well-known method has a linear connection between the number of input signals and the cost price of synchronization. Multi-user commutation scheme is also absent.

Nevertheless some of the mentioned video mixer consoles, for example “Panasonic” (model MX-70), use a different variety of the classic method of digital synchronization, which is economically more reasonable—the so-called manual registration of only the chosen input signal for its following synchronization. But with such switching technology the user is forced to make additional movements—press an extra key on the commutator's keyboard—key for the registration of the input signal. And after the end of registration time—press the switching key. This happens due to two reasons. Firstly, the registration key and the switching key are two different keys. And they are situated in different locations of the commutation device. Secondly, registration of the input signal to buffering occurs after pressing one or another key from different key groups. And first, the user is forced to choose exactly a group in turn. And even though there are only two of these groups, each time the user is forced to think about the additional choice. And inside the group—to choose the keys with the necessary signal source. The reasons of the described problems of simplified manual buffering lie not in the bad ergonomics of the device, but in the obsolete principle of organization of the control of the video mixer console. And even though this principle makes the device cheaper, such price reduction leads to a significant rise in the system's inertness, when the user's abilities upon creating resulting programs in the real time are significantly reduced. And extra movements are “accumulated” in the user's mind, which leads to his untimely tiredness. Therefore the number of errors grows, when the user processes an extended number of input signals—over 10. Therefore on the mentioned variety of a well-known synchronization method, professional commutators and video mixer console with an extended number of inputs (over 10) are not produced. And it significantly limits the users' requirements.

Even though all indicated systems have specified drawbacks, their existence proves the ability to realize the stated method. These well-known systems are essentially different in the principles of modeling and the approaches to controlling the signals both one from another and from the stated method. But these essential differences do not reduce the ability to realize the methods and do not influence the invention purpose.

The prototype of the stated method is the commutation method from Nabuki Murakami described in his patent No US 2009/0109334A1 from 30.04.09. Here a new technical result is obtained, which lies in synchronized commutation of an unlimited number of preliminarily non-synchronized sources. But this is a completely different technical result as exactly synchronization is carried out here with a significant difference—due to the loss of one-two signal packets. Displacement of the time interval on which the input signals are different from each other, in the prototype is compensated thanks to replacement of several non-synchronized packets with foreign ones—for example, black fields. But this leads to the loss in integrity of both the input and the resulting signals. For example, in the case of a video signal this method is inadmissible for using in professional systems of television montage of programs in the online broadcast mode—the so-called PTS. The described technical solution is conditionally used only in everyday areas, from example, in control panels of switching television channels of receivers of television programs.

The aim of the invention is elaboration of a new method of automated digital commutation, which provides synchronized switching of analogue or digital signals from a significant number of preliminarily non-synchronized sources. At that, in such a way that the integrity of the input and resultant signals wouldn't be damaged upon it, i.e. in a way that there wouldn't be any foreign packets, not foreseen by the user's needs, in the structure of the input and resultant signals.

The difference of the new method lies in the fact that commutation of input signals is carried out thanks to selective automated digitizing of input analogue signals and selective automated buffering of digital signals. It is exactly the process of automated buffering of the chosen input signals that gives the opportunity to automatically control the moment of the beginning of the readout of this packet from this buffer, synchronizing it with the readout of a packet from another input signal. This process differs significantly from synchronization described in the prototype. And selective automated synchronization differs significantly from the method of manual direction of the booked signal to a free memory buffer which is used in many of the mentioned video mixer console. At that, in each moment on one tract, i.e. at the time of commutation of one group of signal segments—one program, occurs the buffering of only two input signals—the just booked one and the preliminarily booked one. Here, by “program”, by analogy with television broadcasting, is meant the whole sequence of commutated time segments of input signals that were chosen by the user throughout a certain amount of time.

Thus, in the stated method, automated synchronization of input signals is carried out only relatively to each other—the newly booked input signals relatively to the previous one. Here, automation of signal control provides the fact that the user, by a single key press (or another way of indication on another analogue control device—touch of a finger, of a foreign object, direction of a light or laser beam, voice command, another way; further generalized as “key press”), chooses one or another input signal thanks to its number which is displayed on the control device.

After the press of the key with a corresponding number, a corresponding controlling signal is sent to the system of automated commutation control. This controlling signal is enough for the booked input signals to appear automatically on the input of a free memory buffer for synchronization. Thus, the user doesn't carry out any unnecessary actions to register the chosen input signal on a free memory buffer, as it is realized in the mentioned video mixer consoles. After the end of switching, buffering of the preliminarily booked signals stops.

This method has significant advantages in comparison with other well known ones, being affective and providing minimal self-cost. The method supports unlimited sequence of synchronized signal switches, and the total number of input signals is theoretically not limited: minimally from two to an arbitrary number—100, 1000 and so on, depending on the technique of realization of the stated method.

The delay time between the moment of key press and the moment of the beginning of recording of the first packet of the newly booked input signal to the memory buffer for its synchronization relatively to the previous signal can be ignored, as this time is conditioned by inertness of the control system, i.e. the specifics of the particular realization of the method. In the case of a video signal this time is measured my mere milliseconds. And in the case of a so-called “rough splice” when, starting from a certain video frame, one can expect non-subversive replacement of the previous input video signal with the next input video signal, after the end of synchronization, the time of this switching can also be ignored. The delay between the moment of press of the key with the chosen number and the moment of switching of the program to the signal with this number only equals the duration of one or two packets—i.e. the duration of synchronization itself And this, in the case of video signal commutation, is one or two frames, i.e. not more than 1/12 of a second.

The described synchronization method does not lead to any structure change or violation of integrity of any of the chosen signals before switching or the resultant signal, as it is realized in the prototype, where the time shift between the signals is compensated either by foreign packets or by extension of the pause duration between the frames.

In the stated method, the ability of fully automatic formation of a resultant output program, the so-called “autopilot”, is also expected. The number of the input signal and the corresponding time interval, throughout which the chosen input signal has to go in the program, are fixed on a separate data medium—hard drive, flash-memory or any other specialized memory. The number of such paired parameters is theoretically not limited by anything. And it is only conditioned by the amount of the used memory—the specifics of realization of the method. The user has an opportunity, with the help of the keyboard or another control device, to program the system of commutation control beforehand by a sequence of pairs “number of the chosen input signal—time interval of the presence of the chosen input signal in the program”. And thanks to this programmed sequence, to carry out automatic formation of the program, as the whole sequence of such pairs can be readout automatically from the data medium.

The user also gets an opportunity of using a more complicated system of automated commutation control that has the properties of an external discerning expert device of automatic decision-making—the so-called “artificial intelligence” or expert system. In the “autopilot” mode such expert system can replace the user completely, carrying out commutation automatically. The choice criteria of one or another input signal are described separately at one or another point. Although such criteria do not influence the realization of the method—the processes of the expert system's choice making do not alter the processes of automated commutation that correspond the method.

The sequence of numbers of the signals, chosen by user or the expert system, and corresponding time intervals in the process of commutation, in fact, is also automatically fixed I the form of a protocol on the same data medium—hard drive, flash-memory or other specialized memory. Therefore, in accordance with this protocol, the whole formed program or its edited version can be repeated further by the user in the automatic mode.

The above stated part of the process for the method of automated digital multi-signal multi-program commutation of signals with selective buffering provides the work of only one user on one tract where only one program is being formed. However, on the base of the described, a multi-user commutation method can also be designed. It will be different in the fact that every input analogue or digital signal will be preliminarily multiplied. Moreover the number of input signals-copies can be the same and can equal the number of users in order to provide their simultaneous work. And thanks to the use of the principle of automated synchronization, input signals can be multiplied not preliminarily but only in accordance with the user's request. Moreover, in each moment, the total number of simultaneously multiplied input signals equals only the number of the user's orders in this time interval. Each of the stated variants has its own advantages.

The first variant provides the ability for every user to choose any signal in any moment independently from each other. And the total number of such tracts equals the number of users. At that, the number of input signals and the number of users is theoretically not limited by anything. The minimal number of users equals one. And the minimal number of signals equals two. Therefore each separate program is realized by every user with the use of the total set of input signals. Furthermore, such variety of the multi-user commutation method can be users not only in combination with the automated synchronization method but also with a well known method of manual registration of input signals. But the absence of automation in this case will lead to a significant growth in the self-cost of the corresponding devices.

The second variant has advantages in a more optimized work scheme. And it can be realized exclusively thanks to the presence, in the scheme, of a method of automated control of the commutation process. The following example can be considered. As the second variant of the method, in ten seconds, out of ten users, only three of them have booked signals. At that, each of these three users has chosen the seventh signal. Throughout the indicated ten seconds, multiplied is only the seventh signal in the amount of three exemplars. The remaining signals are not subject to copying as no one has booked them. And, for example, throughout the following ten seconds, the next five users have chosen two of the third, the fifth, the seventh and the thousandth signals. So, they were multiplied: the third signal—in two exemplars, and also the fifth, the seventh and the thousandth signals in one exemplar.

If, however, we unite all of the three varieties of the stated method, there appears and opportunity to optimize the synchronization processes. And, then, the material expenses for the usage of the invention as well. Upon multi-user automated scheme of commutation by means of selective buffering of signals within one tract, the synchronization procedure is carried out thanks to the memory buffer, liberated from the signal at the time of previous switching, which, for the sake of optimization of loading, being liberated from an input signal, becomes common for all the tracts. At that, the system of automated commutation control tracks down the sequence of the users' requests. The request queue is also tracked down, which excludes jamming if by accident there occurs a situation of parallel and almost simultaneous order, when the time interval; between order upon users' parallel request becomes smaller than the time interval of synchronization. And the time interval of synchronization does not exceed two packers, for example, 2/25 of a second for a video signal, where the packer it a frame and its duration equals 1/25 of a second. Then the maximum delay time upon fulfilling such a simultaneous order between the first and the last user equals 2 Lt, where L is the number of simultaneous orders, and t is the average duration of a packet. At that, the number of separate synchronization processes equals the number of users K, i.e. the number of separate program tracts.

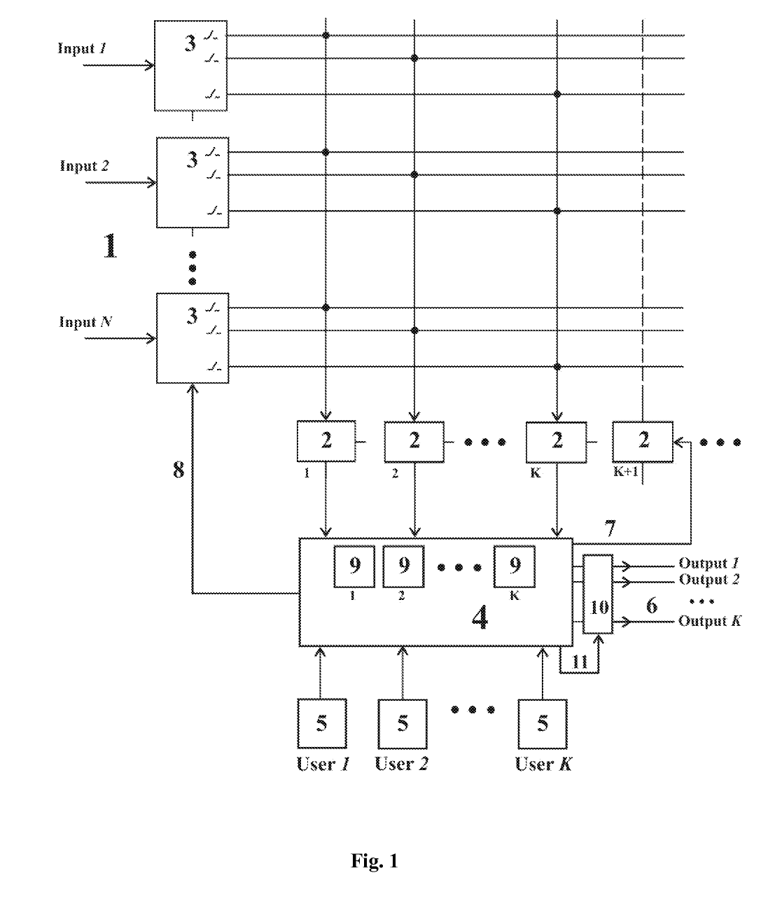

Let us point out that the minimally necessary number of memory buffers for synchronization equals K+1, i.e. the number of buffers is one more than then number of separated program tracts. On the basis of the dependence on the synchronization statistics, additional memory buffers can be used in the process of commutation. As it is shown in the scheme FIG. 1, the buildup of the number of channels and workplaces is carried out by additional copying of signals and adding memory buffer.

If the minimally necessary number of buffering processes is used, then for the described method it makes sense to multiply each input signal in the quantity from 1 to K+1, where K is the number of users. If, additionally (beyond the minimally necessary number), the memory buffer is be used in the quantity of J, then every signal can be maximally multiplied to K+J+1 exemplars. It is obvious that the situation of maximal copying of a certain signal can only occur when all the users order only an exact certain signal. At this moment, other signals are not subject to multiplication.

The stated method has several unique special cases that can be used independently.

The first special case is not selective, but independent sequential buffering of input signals, when the buffering process is carried out constantly cyclically with a certain minimal move. Moreover, the process of such buffering does not depend on the user's choice of the number of the input signal. It significantly simplifies the system of automated control and thereby increases the reliability of work and decreases the cost. The difference of such method lies in the fact that synchronized commutation of input signals is carried out thanks to alternate digitizing of analogue signals and alternate buffering of digital signals. And the unity of the method lies in the fact that in each moment, on one tract, i.e. at the time of commutation of one group of signal segments—one program—buffering of only two input signals occurs. Therefore their synchronization is carried out only relatively to each other. Although not selectively, but continually—cyclically. And only in a certain, user-controlled short moment of time, which theoretically can be very short—to exceed the duration of one packer of the input signals not more than by 1.5-2 times. The switching itself is carried out when, in the proper sequence cycle, occurs a coincidence of the number of the buffered, and therefore the synchronized input signal with an ordered signal number on the keyboard. In such special case this time interval takes an accidental value. And it can last from minimally 2 packets, when the number of the booked signal and the number of the newly buffered signal coincide again, until any other time.

After completion of switching, buffering of the program signal, i.e. the one from which switching to a newly ordered input signal occurred, end. And this memory buffer gets liberated. And the buffering queue of other is continued now in this liberated memory buffer. At that, the proper sequence of buffering starts from any input signals depending on how it is provided in the system of automated commutation control. For example, from the one that has a serial number that follows the number of the newly chosen signal. Or from an input signal that has the first serial number. At this moment, basic for synchronization is the newly included in the program input.

Such variety of the stated method also has a significant advantages in comparison with the well known ones, being more simple and, thus, more reliable. And providing minimal self-cost. At that, the limitation of such special case lies in the fact of supporting not the non-limited, but only the increased total number of input signals in comparison with a well known method of manual buffering. Theoretically, the number of input signals is limited by the relation between the time of the synchronization queue from the previous to the chosen synchronized input signal, and the average duration of a time segment of the chosen signals in the program. If such correlation is not critical for the user, then the number of input signals corresponds the price/quality criterion. At that, such variety of the stated method supports from minimally two to more than ten signals, depending on the technique of the realization of the stated method. Experiments prove that the optimal number of input signals is located in a stretch between 10 and 20. It means that the process of sequential buffering of each input signal can be applied for signal commutation when the switching time is not critical. For example, upon training usage of the method. Or television monitoring of low-motion events.

The above-stated variety of the stated method also supports the multi-user mode. Preliminarily multiplying the input signals, the user simultaneously multiplies pairs of memory buffers for synchronization as on each program tract the multi-user method of alternate synchronization implies two memory buffers. At that, selecting a single collective buffer with such multi-user scheme increases the amount of time spent on awaiting switching and significantly decreases the method's efficiency.

However, from the efficiency viewpoint, this variety of the states method can be divided into two modifications—with preliminary multiplication of input signals and with multiplication of input signals after buffering. Statistical experiments prove that for a number of users which is significantly smaller than the number of input signals, the following multiplication of input signals upon sequential buffering is more optimal. For example, for 5 users working in parallel, if the number of input signals is up to 20, the following multiplication allows to design the buffering sequence more effectively. And to single out 4 independent queue groups.

Post-synchronization multiplication implies that each pair of user buffers works out only its own part of the cycle of sequential synchronization in its group—synchronizes only its emphasized group of input signals. I.e., the set of all buffers becomes collective. For example, for 20 input signals, the group creates by 4 input signals for 5 users. Then the situationally program buffer of each of the users can also be synchronizing for another user. Such control logics reduces expenses on multi-user buffering and, in comparison with preliminary multiplication upon multi-user buffering, reduces the average time of awaiting switching.

Let us draw attention to the fact that upon automated selective buffering of input signals and post-request multiplication of the chosen input signals for the multi-user scheme described in the main part of the stated method, preliminary or post-buffer multiplication of the input signal is not an essential sign. From the efficiency viewpoint both schemes are equal.

If the number of users is insignificantly smaller, equals or exceeds the number of input signals (as, for example, upon using the method in the training mode of a group of directors-trainees upon an insignificant number of input signals), the efficiency of this variety of the stated method with sequential buffering and subsequent multiplication becomes maximal. For example, upon using 10 input signals by 10-100 directors. Upon such configuration the stated method allows to use a cycle of sequential buffering with an interminable queue time. So, as a matter of fact, to define the number of buffers, equal to the number of input signals—10 buffers for this example. The sequence cycle of each signal to be set equal to infinity—only one signal. And multiply the previously buffered ones, that is, synchronized signals. They are already subject to any mutual commutation. Here, by “insignificantly smaller” we imply such deviation of the values towards reduction, compensation of which in the given conditions by means of adding extra memory buffers does not decrease, but even increases efficiency. For example, for 7 users synchronization of 10 input signals by 10 buffers with subsequent multiplication of the previously synchronized input signals is more effective than, for example, by 8 buffers with one selected common buffer and preliminary multiplication of input signals on demand, if the processed event is very dynamic. If it is a low motion event and it bears a merely educational character, a low budget scheme can be chosen.

The second special case is multi-program commutation of an arbitrary number of preliminarily non-synchronized input signals on signals from users' own controlled sources—computers, streamers, tape recorders, flash recorders, etc., later called autologous signals. At that, the method allows to carry out buffering not of the input signals, but the general preliminary buffering of unlimited number of all autologous signals in one common buffer or group of buffers. Or to carry out selective buffering of any sequence of groups of autologous signals. These actions can be used to simplify the process of controlling the synchronized start of an autologous signal relatively to clock-signals of any input signal—the process of buffering significantly simplifies this section of the system of automated control, responsible for logical operations of synchronous start of an arbitrary (that is, arbitrarily complex) set of groups of autologous signals. It is implied that any input signal with a periodically-discreet, i.e. packet structure already has or can be synthesized in the process of packet movement or near the source, or near commutation, an autologous clock-signal that provides internal integrity of the input signal.

As experiments show, such technical solution is especially effective in the case of a need of repeated start of one autologous signal for commutation with different input signals, although not at the same moment, which would be reached by multiplication of the autologous signal, but at different, yet close, moments of commutation with different, yet close, moments of start. Efficiency of buffering is conditioned by this exact closeness of the moments of start and commutation on the one hand, and high probability of stability of such situation on the other hand, which is common for, for example, a television broadcast schedule, when fragments of advertisement units are very close to each other on a multitude of television channels all over the world. The process of buffering significantly increases flexibility upon forming an arbitrary number of autologous signals. It also provides support of arbitrary moments of their start which is significantly more different to realize in any other way. For example, upon using the usual hard disk drive. At that it is implied that even upon switching from any input to any autologous signal, within this tract it is possible to carry out further switching to any autologous signal with any sequence.

Thus, the difference lies in the fact that for synchronized switching, not all commutated signals are subject to buffering, as in the main procedure of the stated method, but only the autologous signals. At that, the moment of start of the autologous signal is estimated by the system of automated control relatively to clock-signal of a non-bufferable input signal. A group of buffers, at that, even if it is organized by a set of different groups, can be either a whole integral controlled memory buffer or a group of independent buffers. Such configuration of buffer is chosen by the user on the basis of the statistics of starts of autologous signals and the statistics of arbitrary excerpts of switches of a set of autologous signals to a set of input signals. Buffer configuration is declared in the system of automated control.

The process, described in this special case, can be the basis of devices of remote multi-channel television group cutting out of a multitude of foreign packers of television programs—for example, advertisement units—in any group of television channels on any limited broadcast area according to a group of cutting out time schedules formed in advance. In other worlds, for television broadcasting, the stated method allows to solve the technical problem of conjunction most optimally: multitudes of input television channel signals, multitudes of autologous foreign television segments, multitudes of starting times of each of the segments, multitudes of broadcast areas, multitudes of orderers of these commutation cuttings out and multitudes of owners of rights to television channels. At that, if in the process of exploitation, the user detects a new set of multitudes, not taken into account before exploitation, the method implies natural integration of these new multitudes.

A natural development of this special case is multi-program commutation of previously non-synchronized input signals both between each other and on autologous signals in accordance with the user's order. Moreover, for synchronized switching, both starting autologous and input signals are subject to buffering. And buffering of input signals can be carried out in accordance with any scheme chosen by the user—as by means of selective buffering, as by means of sequential buffering. After the buffering process, the system of automated commutation control controls both the synchronized start of each of the groups of autologous signals from memory buffers relatively to the moment of the beginning of the packet movement phase, and the process of synchronized switching of any signal to any signal.

The third special case is a half-automated mode of both selective and sequential buffering, when the user presses the key with the number of the chosen input signal twice. That is, for even bigger reduction of the realization cost of the above described varieties of the stated method, the system of automated commutation can be carried out with simplified logics. The difference from the described situation in the case of, for example, “Panasonic” switchboard lies in the fact that in this special case for these two operation, the user uses the same, that is, the only key with the number of the chosen input signal. Upon the first press, registration is carried out on the input of a buffer free from buffering. Upon the second press the commutation process starts. At that, further exceptionally formal treble (or other multiple) key press does not lead to synthesis of new technical solutions.

Each of the stated method's varieties also considers the process of aggregation of input, autologous and output signals. One of the main consequences of this process is the users' ability to independently control the switching time from one buffering input or autologous signal to another one.

The ability of aggregation of arbitrary types and formats of input signals is given to the user so that it would be possible to control the commutation time thanks to connecting any additional external devices (effect block, external video mixer console, computer or a set of parallel computers, etc.) that carry out subsidiary processes that are supposed to precede synchronization. It is implied that these processes can occur both in memory buffers and external devices, depending on where they will pass faster. So the number and type of such external devices is not limited by anything.

Here, by “external device” implied is any device that generally has an ability to be controlled by a key press or any other way of indication on another similar control device.

It is known that there is a considerable number of additional processes that significantly diversify signals of different types. Such processes are: the absence of clock-signals or changes in their characteristics, change in the frequency of packet movement (even in the dynamic mode—during the transfer to the pace of commutation), change in one of the packet size or proportions of all its linear characteristics, change in the density of colors in analogue or digital formats, the use of algorithms of preliminary compression before the transfer of signals to the commutation place, dynamic change of the compression algorithms during transferring, etc. As a rule, all these processes prevent direct synchronization and require the process of aggregation, that is bringing together all input signals that are meaning for synchronized switching, to a single unified multitude.

That is why it is exactly aggregation that allows to use the methodology of efficient transfer of high-stream digital signals (such as 3G-SDI) from the sources to the commutation place, thanks to the support of optimal algorithms of compression and decompression of input signals in a form and format that are convenient for the user—from algorithms with a small coefficient of frame compression (without information loss) to more complex procedures.

Moreover, if the user is obliged to use compression-decompression of input signals for the transfer, the stated method, thanks to aggregation of signals, allows to use these processes more efficiently that in the well-known methods: for correct commutation only one chosen signal can be decompressed in the process of its buffering instead of excessive decompression of all signals at the same time.

None of the above-stated external and additional processes makes any changes in the processes of the described methods.

Such approach stimulates the user to create own libraries of program codes of various algorithms of digital processing of input signals—from transformation of their properties to digital effects-transfer from one input signal to another, like the ones in the case of a classical smooth video signal commutation, or as it is also called “cross-transfer”, “curtain”, “picture in picture” or other algorithms.

Another kind of aggregation in the stated method is the ability of any user to order copying—multiplication—of any input program signal of another user and to use it as an autologous signal—to carry out synchronized switching from any input or autologous signal to this multiplied output one.

The method also provides an opportunity of flexible manual additional “plug-and-play”-installation of the necessary number of memory buffers for simultaneous synchronization of the necessary number of input signals relatively to any preliminarily chosen one not only for commutation but also for the procedure of aggregation of output signals. At that, aggregation both independently on each output tract and jointly by any of the multitudes of tracts at the same time. Moreover, each of the united output signals can have a resulting form depending on the used unification algorithm—from the classic multi-ary—binary, quaternary (or as it also called “quadratic”), octary, etc.—until any arbitrary superposition of signals which is built upon some resultant proportions of every input signal. At that, the signals can be aggregated both without changing the size proportions of the initial packet and with changing these proportions.

Upon simultaneous receipt of the whole single program, distributed among all output tracts, its characteristics can also differ from the characteristics of the initial input signals—frequency of packet movement, methodology of compression or chromaticity coding, packet proportion, etc. For example, a common resultant output television program can be proportionally distributed among 10 output tracts and have a form of a circular closed panorama which is formed by mutually joined frames from 10 input signals, height and length proportions of which are transformed by a single algorithm. And in each of them, 10-20-100 or another arbitrary number of input signals can be enclosed by the “picture in picture” principle. And each of these enclosed input signals can also have its own frame proportions. At the time of realization of one or another event, such single resultant aggregated panorama can be broadcast by means of a specialized multi-input and multi-ray projector, a set of plasma panels enclosed in a circular surface, or any other system of displays. Or to be used in any other way. The same aggregated output signal can be compressed for further transfer or be transformed in the 3G-SDI format. I.e., theoretically, the method does not imply any restrictions concerning the aggregation algorithms and characteristics of output packets in resultant programs.

An important feature of the stated method is the fact that it does not put any user restrictions on the construction of memory buffers. Memory buffers can be either one integral complete controlled chip, internal sectors of which are only logically divided onto different buffers, or a group of independent memory chips. These modifications do not make any principal changes on the processes of buffering of input or autologous signals.

At that, the stated method does not put any restrictions on the distance between the users, the sources of input signals, the system of automated commutation control and received of output signals. As controlling channels, any communication tracts can be used, including local or global computer networks (Internet, etc.). Thanks to this, for example, the method allows to organize the principle of remote real-time teaching of groups of directors during broadcasting of events, distant from the consultant-teacher.

In the stated method, the procedure of digital bringing of autologous signals to the format of input signals is considered by default. By default, also considered is the presence of compression procedures before the input and decompression procedures after the output of input and/or autologous signals, if it is necessary for reduction of tract expenses. These procedures are not crucial and have no significant influence on the essence of the stated method.

FIG. 1 shows a scheme that illustrates the method with selective buffering of input signals. Here is shown the sequence of processes and location of the known devices that are used in the method algorithm. Number 1 indicates N input signals, 2—memory buffers from the 1^{st} one to K+1, each of which has an input and output for the synchronized signal, and also an input for the controlling signal, and, moreover, the picture shows a situation when the user's next order can be expected, so the current (K+1)-st memory buffer is empty, therefore the channel, free from the input signal, for synchronization is conditionally shown with a dotted line, and the possibility of further installation of new memory buffer is shown with dots, 3—the process of input preliminary or just ordered multiplication of N input signals, 4—united system of commutation control and the process of digital commutation of input signals, 5—users' keyboards, 6—output programs which number equals K, 7—controlling signal that provides automated transfer of the chosen input signal to the input of a free memory buffer for synchronization, here to reduce the picture's overload, the arrow is conditionally shown only up until the memory buffer which is free from the input signal, 8—controlling signal that provides automated control of the process of multiplication of input signals, 9—specialized memory media for fixation of the sequence of “number of the input signal—duration of the chosen input signal in the program” pairs, the number of which equals the number of users K (in the picture it is shown included in the system of automated commutation control), 10—process of aggregation of output signals, 11—controlling signal that provides automated control of the aggregation process of output signals.

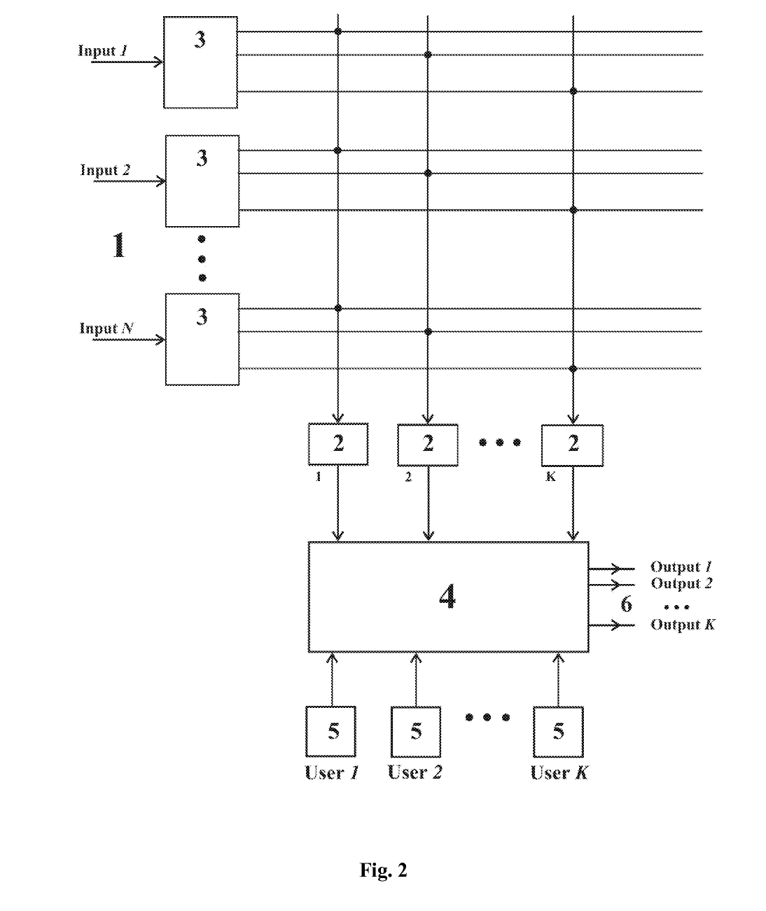

FIG. 2 shows a scheme that illustrates a special case of the stated method—sequential buffering with preliminary multiplication of input signals. Here, number 1 indicates N input signals, 2—paired memory buffer from the 1^{st} to the K-st one, 3—process of preliminary multiplication of N input signals, 4—united system of commutation control and the process of digital commutation of signals, 5—the users' keyboards, 6—resultant programs, the number of which equals K.

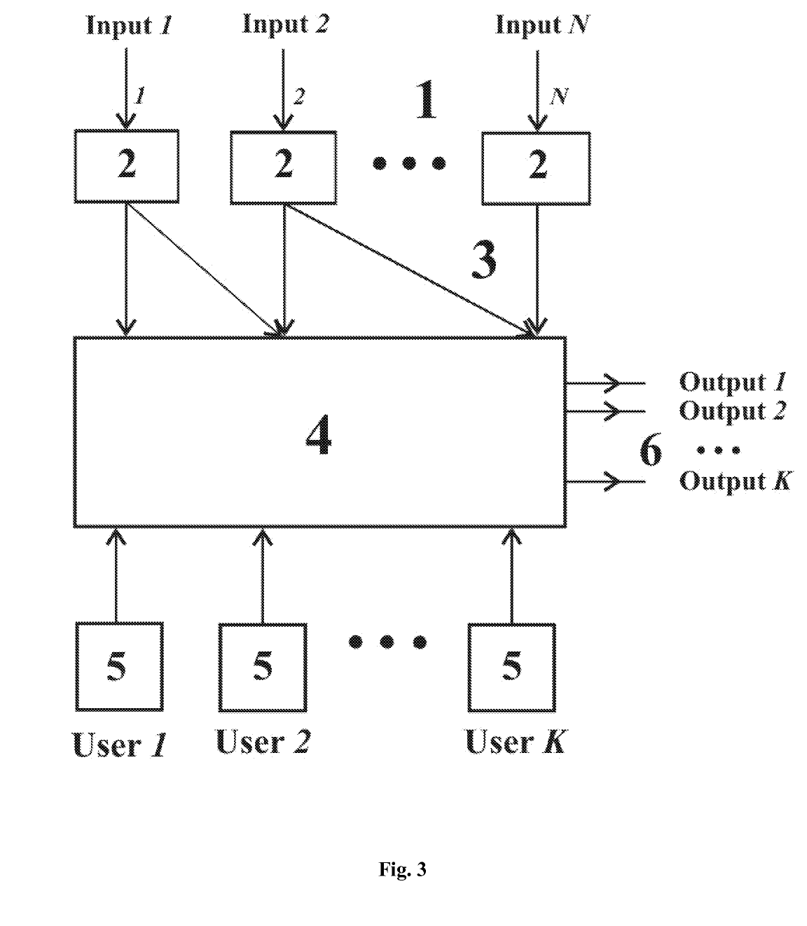

FIG. 3 shows a scheme that illustrates a special case of the stated method—sequential buffering with an infinitely long queue time and the subsequent multiplication of input signals. Here, number 1 indicates N input signals, 2—single memory buffer from the 1^{st} one to the N-th one, 3—process of subsequent full or post-request multiplication of N input signals, where for reduction of drawing overload only several multiplying tracts are conditionally shown, but all possible combinations are implied, 4—united system of automated commutation control and the process of digital commutation of signals, 5—the users' keyboards, the number of which equals K, 6—resultant programs the number of which equals K.

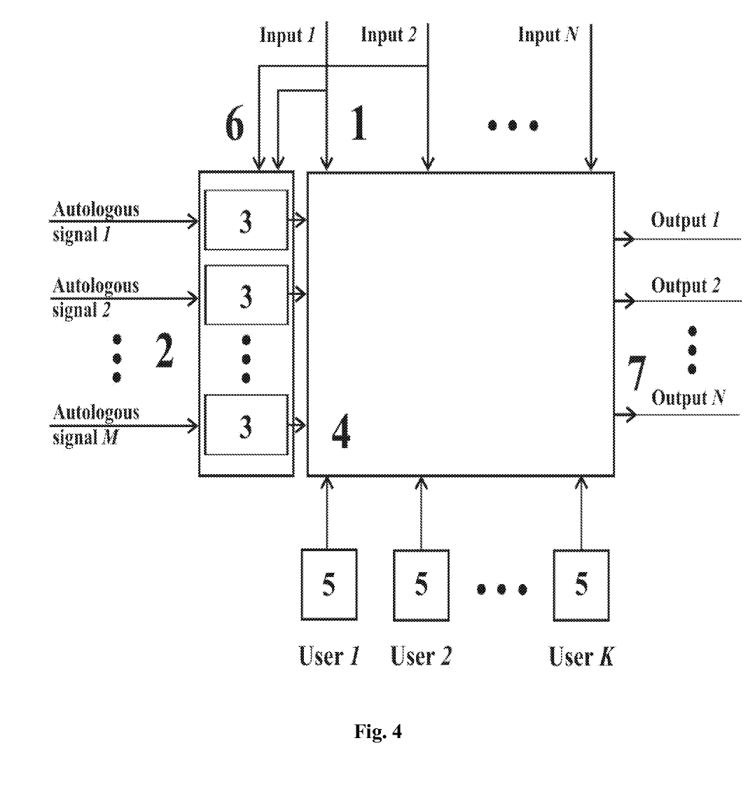

FIG. 4 shows a scheme that illustrates a special case of the stated method—commutation between each input signal and each combination of autologous signals in a way that between each other, the input signals are not commutated. Here, number 1 indicates N input signals, 2—autologous signals from the 1^{st} one to the M-st one, 3—single common buffer or groups of independent memory buffers, 4—united system of automated commutation control and the process of digital commutation of signals, 5—the users' keyboards, the number of which equals K, 6—process of separation and direction of clock-signals in the common buffer or in a group of memory buffers, 7—resultant programs, the number of which equals the number of input signals N.

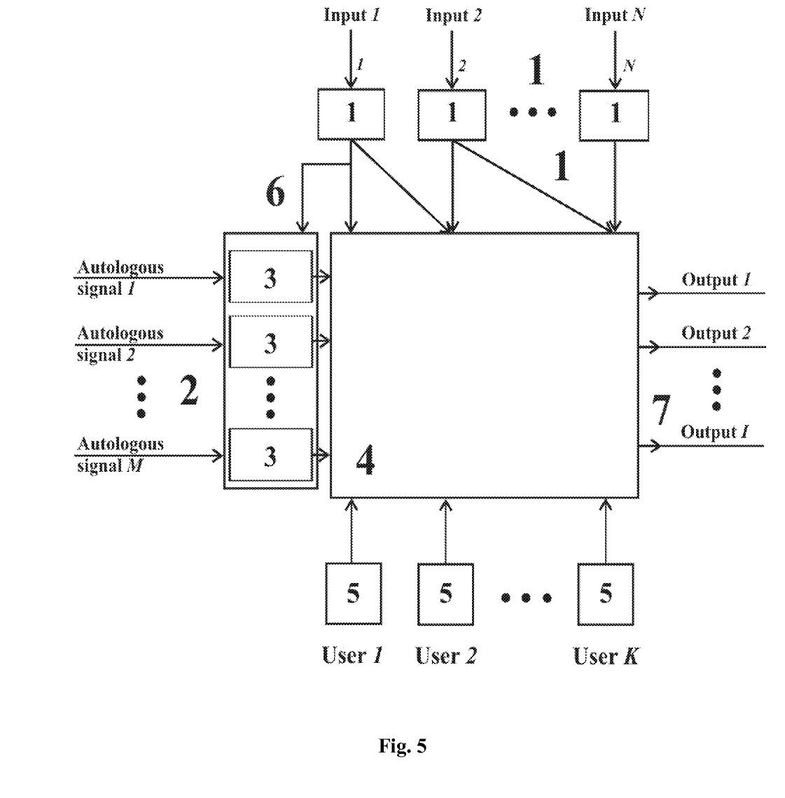

FIG. 5 shows a scheme that illustrates synchronization and commutation of input and autologous signals from any one to any one. Here, number 1 jointly indicates: N input signals, N single memory buffers and the process of subsequent full or post-request multiplication of input signals, 2—autologous signals from the 1^{st} one to the M-st one, where M—the number of autologous signals, 3—single common buffer or groups of independent memory buffers, 4—united system of automated commutation control and the process of digital commutation of signals, 5—the users' keyboards, the number of which equals K, 6—process of separation and direction of clock-signals for controlling that start of autologous signals in the common buffer or group of memory buffers, 7—resultant programs, the number of which equals I (value I can be any relatively to K—more, less or equal).

The method also implies the presence of additional user tracts of all input and autologous signals for their monitoring and visual control. In the schemes, these tracts are conditionally shown as lines directed at keyboards 5. For transparency of the schemes, the following devices that visualize these signals, as, for example, television monitors in the case of television or computer signals, are not shown in the pictures. It is also implied that special constructive features of keyboards allow the users to worn with an increased number of signals.

The materials of the application use the following names of some elements:

autologous signal—in technical meaning an “own” signal is implied, i.e. a signal which is transferred from sources located near the user, so that its start can be controlled by the user.
buffering an input digital signal—a classical process of byte-by-byte recording of the packet to a memory buffer and its byte-by-byte readout; at that, the readout process does not depend on the recording process, and the readout can be started both right after the start of the recording process and after the moment when, for example, the last byte is recorded, which allows to synchronize them;
clock signal—is an accompanying auxiliary signal for a signal with a periodically-discreet structure, that provides integrity of playback of the packet movement of the signal by the receiver—a television set, a computer display, etc.
keyboard—a generalized control device as a set of controlled positions (keys) each of which gives the user an opportunity to order a signal with a certain number, in the scheme it is shown by position 5;
key press—in a generalized meaning is the user's indication of a chosen input signal with the help of a keyboard; it can be carried out in any other way and on another similar control device—a touch of a finger or a foreign object to any device (keyboard, screen, etc.), direction of a light or laser beam, voice command, another way;
memory buffer—a variety of Random Access Memory, the volume of which is provided by a signal multiple to one packet, for example. One frame in a video signals; the total volume of one or another memory buffer can constitute from one packet to a multitude of packets, depending on the purpose of the buffer's use: if for current synchronization of input signals, then the volume of one packet is enough, if it is for synchronization of the start of autologous signals, the volume can be increased significantly; that's why a memory buffer can be either an integral complete number, the internal sectors of which are logically divided into different buffers, or a group of independent memory chips; in the majority of schemes it is shown with position 2;
packet movement occurs by random principle—such movement that is conditioned by sources that does not provide the ability of synchronized start of the signals if there are several sources; such sources are also video cameras that, in professional realization, imply the possibility of forced artificial synchronization after the start of signals by a separate device (located near the video camera or built in its system) by a single centralized clock-signals that is distributed from the place of future commutation to remote signal sources; at that, such technology is excessive and unreliable—upon further extension of the number of video camera sources and considerable remoteness of the tracts (due to, for example, the worldwide network), the commutation system becomes as non-synchronized as without the use of clock-signals.
separate program tract—channel that transfers the resultant program signal from the user (program director in the case of television broadcast) to further exploitation, in the scheme it is shown by position 6;
synchronization channels—input channels to memory buffer, on one of which there always exists the previous signal, and on the other one—a signal from the previous source, which needs to be synchronized with the previous one for the sake of its correct switching relatively to the previous one, in the scheme it is conditionally shown as a line directed to a memory buffer, position 2;
the system of automated commutation control—a classic set of logical operations concentrated on one or several digital data media in a form of a program code of one or another format, elaborated by a third party group or one user, but supported and developed by the user in the process of exploitation; in the process of exploitation; this program code realizes the following functions in an automatic or automated (that is, with the users share) mode—sends a set of electronic controlling signals to different processes and devices involved in the method, and also analyses the set of response signals, after which it generates a new set of controlling signals; the system can also exhibit properties of a discerning expert device of automatic decision-making—an expert system that can fully replace the user, carrying out the commutation automatically;
tract—electronic channel of movement of input signal to one or another output, in the scheme it is shown by lines from inputs to outputs;
user (director in the case of television commutation)—specialist who carries out real time montage of the program, choosing necessary signals (video signals from television cameras in the case of television commutation), not shown in the scheme.

The stated concept allows to significantly reduce the self-cost of servicing of each channel.

1. Method of automated digital multi-program multi-signal commutation with selective buffering of signals with packet, i.e. periodically-discreet structure in which moments of the beginning of packet movement happened by an accidental principle—signal sources were turned on by the user or users in different moments of time, that is, all phases of packet movement between the signals, which will be later called “input signals”, are not synchronized beforehand, and that's why for their commutation at the time of switching between one input signal and another input signal, it is critical to maintain the integrity of several first packets of a segment of an output signal which is different in the fact that on each tract there are only two memory buffers used, each one of which situationally fulfills a similar function—either buffering, which also means synchronization of a current input signal located in the program, or buffering and synchronization of a newly chosen input signal for switching it in the program, and a synchronized commutation is carried out automatically thanks to selective buffering of digital signals in such a way that either one or another signal is chosen by its number; and for a system of automated commutation control, this number is enough for the controlling signal, so that the booked input signal would automatically get on a free memory buffer for synchronization; at that, at each moment on one tract, i.e. at the time of commutation of one group of signal segments—one program, buffering of only two input signals occurs—newly booked input signal and the previous one, and also their synchronization between each other; and after the conclusion of switching, buffering of the previous input signal ends and the buffer gets liberated for buffering and synchronization of the new signal.

2. Method in accordance with paragraph 1, which is different in the fact that selective digitization of analogue input signals before digital buffering is carried out.

3. Method in accordance with paragraph 2, which is different in the fact that the number of the chosen signal is displayed on the keyboard or other analogue device;

4. Method in accordance with paragraph 3, which is different in the fact that after a user's single indication of the number of the chosen input signal—press of a corresponding key or another similar action or another controlling device—a touch of a finger, of a foreign object, direction of a light or laser beam, voice command, another command method, further generalized as “key press”, the keyboard or another device of control with controlled positions sends a corresponding control signal to the system of automated commutation control.

5. Method in accordance with paragraph 4, which is different in the fact that in the system of automated commutation control, half-automatic mode is used, when the user presses the key with the number of the chosen input signal twice, at that, leaving a short time interval between pressing the button, that he can control; after pressing for the first time, the system of automated commutation control sets the chosen input signal at the input of a program-free memory buffer, the chosen input signal starts buffering, after which the system of automated commutation control synchronizes the moment of the start of the readout of this input signal from this memory buffer with the movement of the packets of another input signal located in the program buffer at that moment, at that, this whole process lasts no longer than 1-2 packets, and at the second press of the same key, the process of commutation starts.

6. Method in accordance with paragraph 5, which is different in the fact that between the moment of pressing the key with the number of the chosen input signal for the first time and the moment of pressing this same key for the second time, there can be a time interval of any duration necessary for the user.

7. Method in accordance with paragraph 6, which is different in the fact that each input analogue or digital signal is previously multiplied, at that, the number of signals-copies is the same and equals the number of users whose simultaneous work is provided by such a means of commutation in such a way that each user can pick up an arbitrary input signal at any moment of time, which provides the users' independence on each other and the multi-program mode, and the whole number of such tracts equals the number of users and at that, the number of input signals and the number of users is not restricted by anything, and the minimal number of users equals one and the minimal number of signals equals two, because each separate program is carried out by each user with the usage of a general set of input signals.

8. Method in accordance with paragraph 7, which is different in the fact that each input signal is multiplied only in accordance with the user's request and at that, in each moment, the general number of simultaneously multiplied input signals equals only the number of the users' requests from this segment of time, which is controlled by the system of automated commutation control.

9. Method in accordance with paragraph 8, which is different in the fact that with an automated multi-user commutation scheme based on post-request duplication of input signals, in one tract, for the sake of synchronization of input signals between each other, the procedure is carried out thanks to buffering of the input signal which is free from the previous input signal at the time of the previous switching of the memory buffer from another tract, which, for the sake of optimization, after getting free from an input signal, becomes mutual for all the tracts because the minimal necessary general number of memory buffers is K+1, where K is the number of users and the number of tracts, for both are equal; At that, the system of automated commutation control tracks down the succession of user's requests and forms their sequence.

10. Method in accordance with paragraph 9, which is different in the fact that a possibility is provided, of installing extra memory buffers through a flexible manual plug-and-play for increasing the number of memory buffers mutual for all the tracts.

11. Method in accordance with paragraph 10, which is different in the fact that memory buffers can be either an integral complete controlled memory device—a single chip—or a group of independent controlled memory devices.

12. Method in accordance with paragraph 11, which is different in the fact that multi-program commutation of preliminarily non-synchronized input signals is realized not between each other but only for the signals from own controlled sources, i.e. such sources in which the user can control the start of the signal, that's why these signals are later called “autologous signals”; for synchronized switching not the input signals are buffered, but only the starting autologous signals, which is realized by means of preliminary buffering of either the whole summation of a theoretically infinite multitude of autologous signals in one mutual buffer or a group of memory buffers, or by means of buffering of any sequence of independent groups of autologous signals.

13. Method in accordance with paragraph 12, which is different in the fact that after the process of buffering, the system of automated commutation control controls the synchronized start of each group of autologous signals from these memory buffers with respect to clock-signals, distinguished by the system of automated commutation control from the booked input signal, after which synchronized switching is carried out, of only one of the input signals to one of the autologous signals, or one of the autologous signals to an autologous signal, or an autologous signal to an initial signal.

14. Method in accordance with paragraph 13, which is different in the fact that upon multi-program commutation of preliminarily non-synchronized between each other and on own signals input signals, in accordance with the user's request, for synchronized switching, both starting own signals and input signals are buffered; at that, buffering of input signals can be carried out in accordance with any user-chosen scheme; and after the process of buffering, the system of automated control controls both the synchronized start of each group of autologous signals from memory buffers as to the moment of the beginning of the packet movement phase, and the process of synchronized switching of any signal to any signal.

15. Method in accordance with paragraph 14, which is different in the fact that the number of the input or autologous signal and the corresponding time interval when the chosen input or autologous signal will be directed into the program is readout automatically: either from an external discerning expert device of automatic decision-making that has the means and criteria of automatic choice of an input or autologous signal without the user's participation, or from a preliminarily formed data set in the separate memory—hard drive, flash memory, specialized electronic data medium or any other external memory; and the total number of such paired parameters is not restricted by anything and is conditioned just by the volume of the used memory of such type, i.e. the specifics of the realization method;

16. Method in accordance with paragraph 15, which is different in the fact that a sequence of the numbers of chosen input or autologous signals and corresponding time intervals of the user's work or an external discerning expert device of automatic decision-making—commutation process—is fixed in the form of a commutation protocol in a separate memory—hard drive, flash memory, specialized electronic carrier or any other external memory, thus according to this protocol, the user can later completely repeat the whole created program in the automatic mode or make all the necessary corrections in this protocol and repeat the program considering the corrections.

17. Method in accordance with paragraph 16, which is different in the fact that besides the commutation process, the aggregation process of input or autologous signals is also supported, which provides the ability for each user to control the duration of switching from one buffered signal to another one and add to this process any other external procedures and devices of additional signal processing, that allow to carry out additional processing of input signals during the chosen time interval of switching, and also to create own libraries of program codes of various algorithms of processing and transition from one input signal to another one.

18. Method in accordance with paragraph 17, which is different in the fact that on each output program tract, an ability is provided to use the aggregation process of any group of buffering input and autologous signals for obtaining united output signals, each one of which can have an arbitrary resultant type depending on the used unification algorithm—from the classic multi-ary—binary, quantary, octary, etc.,—to any union; at that on each output tract, each resultant program can be carried out both without changes in the characteristics of the initial packet, and with changes in these characteristics depending on corresponding aggregation algorithms which are independently on each other chosen by the users in the multi-user mode.

19. Method in accordance with paragraph 18, which is different in the fact that a separate type of aggregation of input or autologous signals is the ability of every user to book copying—multiplication—of any output program signal from another user and use it as an autologous signal—carry out synchronized switching from any input or another autologous signal to this multiplied output one.

20. Method in accordance with paragraph 19, which is different in the fact that there is such a multi-user mode of the process of simultaneous aggregation of output program signals on an arbitrary number of tracts, that a sole summary program is created—arbitrary superposition of signals which is built on a general arbitrary resulting group of characteristics of each input signal.

21. Method in accordance with paragraph 20, which is different in the fact that an opportunity of flexible extra manual “plug-play” installation of the necessary number of memory buffers is given, for simultaneous synchronization of an arbitrary necessary number of input or autologous signals with any preliminarily chosen one, depending not only on the need of the commutation procedure, but also on the procedure of aggregation of any set of output program signals.

22. Method in accordance with paragraph 21, which is different in the fact that input, output, autologous signals and controlling signals from the system of automated commutation control can be distributed through any communications including local or global computer networks, which means that no restrictions on the distance between the sources, the users, the system of automated commutation control and the receiver of the output signals are put.

23. Method of automated digital multi program multi-signal commutation with alternate signal buffering with packet, i. e. periodically-discreet structure in which all phases of packet movement between the input signals are not previously synchronized, which is different in the fact that independent alternate buffering of input signals is carried out, when the process of buffering is carried out constantly and cyclically with a user-controlled time step—from the minimally possible one, i.e. exceeding the duration of one packet of an input signal by no more than 1.5-2 times, to any other one, up to an infinite one; and besides, the process of such buffering does not depend on which input signal the user chooses; and the switching itself is carried out when in the sequence cycle, there's a coincidence of the number of the buffered, and hence the synchronized input signal, with the booked signal number, and in this process this time interval takes a random value; at that, after the end of switching, buffering of the program input signal from which the switching was carried out ends; this memory buffer gets free and the buffering queue in continued in this free memory buffer; at that, the sequence of buffering starts from any input signal; at this moment, the newly included in the program input signal becomes basic for synchronization.

24. Method in accordance with paragraph 23, which is different in the fact that a half-automatic mode is used in a system of automated commutation control, when the user presses the key with the number of the chosen input signal twice; at the time of pressing for the first time at the memory buffer where the input signals that are not located in the program are alternately buffered, the sequence is reset to the chosen input signal, if the number of the chosen input signal does not coincide with the one that is being buffered at that particular moment, the progress of the buffering queue stops, the chosen input signal starts buffering, after which the system of automated commutation control synchronizes the moment of the beginning of the readout of the input signal from this memory buffer with the movement of the packets of another input signal located in the program buffer at that moment, and at that, this whole process lasts no longer than 1-2 packets; and at the time of pressing the same key for the second time, the process of commutation starts; at that, between the moment of pressing the key for the first and for the second time there can be a time interval of any duration which is necessary for the user.

25. Method in accordance with paragraph 24, which is different in the fact that preliminary duplication of input signals corresponding to the number of users is carried out, and at that, each user has only two input signals buffered, because on each program tract, each user carries out alternate synchronization of the signal pairs independently on each other.

26. Method in accordance with paragraph 25, which is different in the fact that for the number of users which is smaller than the number of input signals, synchronization of input signals by means of their alternate buffering upon preliminary duplication of the input signals, is carried out independently on each tract, and in a quantitative group of buffers, herewith each pair of user buffers alternately synchronizes only its emphasized group of input signals, which is defined upon configuration by the system of automated commutation control, and herewith in a way that the total number of buffers equals the sum: the number of memory buffers for synchronization of program input signals on the output tracts plus the number of buffers for collective alternate buffering of other input signals.

27. Method in accordance with paragraph 26, which is different in the fact that in the case when the number of users is slightly smaller, equal or exceeds the number of input signals, the cycle of alternate buffering with an infinite queue time is used, which means that a number of buffers, equal to the number of input signals, is set: on one buffer there is only one input signal; after this, already buffered signals are duplicated, that is, the synchronized ones, applicable for mutual re-commutation in an arbitrary sequence and arbitrary amount of copies.
